(19) United States
(12) Patent Application Publication
(10) Pub. No.: US 2013/0171294 A1
(43) Pub. Date: Jul. 4, 2013

(54) Nutritional Compositions

(71) Applicant: Glen Patrick Martyn, Leicestershire (GB)

(72) Inventor: Glen Patrick Martyn, Leicestershire (GB)

(73) Assignee: Omniceutica Limited, Leicestershire (GB)

(21) Appl. No.: 13/812,241

(22) PCT Filed: Jul. 27, 2011
(86) PCT No.: PCT/GB2011/051432

§ 371 Date: Mar. 11, 2013

(30) Foreign Application Priority Data
Jul. 27, 2010 (GB) 1012539.1

(51) Int. Cl. A23L 1/29

(52) U.S. Cl. CPC A23L 1/296
USPC 426/2; 426/656; 426/648; 426/74; 426/67; 426/66; 426/599; 426/595; 426/597; 426/592; 426/598; 426/580; 426/72; 426/71; 426/61

(57) ABSTRACT

The invention relates to compositions comprising novel blends of nutritional ingredients and solid, semi-solid and beverage compositions comprising such blends. In particular, this invention relates to rehydration, energy and recovery beverages (e.g. sports drinks), compositions for support of weight management, as well as digestive, bone, cognitive and heart health.

### FIELD OF THE INVENTION

The invention relates to compositions comprising novel blends of nutritional ingredients and solid, semi-solid and beverage compositions comprising such blends. In particular, this invention relates to rehydration, energy and recovery beverages (e.g. sports drinks), compositions for the support of weight management, as well as digestive, bone, cognitive and heart health.

### BACKGROUND OF THE INVENTION

Over the past several decades, there has been extensive research conducted on the role hydration and carbohydrates play in improving exercise performance. This research led to the development of sports drinks for use during exercise which are isotonic. That is to say, they have an osmolality close to that of blood plasma, which is about 290 mmol/kg. Isotonic drinks are rapidly emptied from the stomach and absorbed in the intestine. Increasing the osmolality of the drinks by adding more glucose slows the rate of gastric emptying and initially draws fluid from the circulation into the gut, causing an unwanted dehydrating effect. Hence, most sports drinks contain glucose at a concentration of 4-8% w/v, together with a small amount of sodium (10-60 mmol/l, usually as sodium citrate) which optimises the rate of glucose and water absorption, as well as numerous essential electrolytes such as potassium, magnesium and chloride. Many studies have shown that consumption of a sports drink during exercise containing carbohydrate and electrolytes enables athletes to extend their endurance compared with the consumption of water alone. It is now well established that the consumption of carbohydrate containing beverages is beneficial for endurance exercise performance. It has become a common practice in many sports for the participants to ingest sports drinks during both competition and training, for example in cycling, triathlons, marathons, football or rugby. It is also known for participants in recreational pursuits such as walking and disco dancing to consume carbohydrate containing beverages to improve endurance performance. The beverages are also consumed to improve mental alertness during such activities.

Fatigue during extended exercise is associated with both dehydration and low blood glucose concentration. Low blood glucose levels also impair mental concentration and motor skills. When a sports drink is consumed during exercise, the carbohydrate is transported from the circulation into the muscle where it can be converted into energy.

Usually, glucose uptake is controlled by insulin. However, during periods of intense activity there is a decrease in the production of insulin and glucose is transported into the muscle primarily by the contraction of the muscle cell. It has been shown that when insulin is stimulated during intense exercise, there is an increased uptake of glucose. Increasing carbohydrate consumption during exercise can stimulate insulin up to a point, but when high levels of carbohydrate are consumed during exercise, they do not empty from the stomach rapidly. Therefore, carbohydrate intake becomes rate limiting in its ability to stimulate insulin. Previously, it has been found that when protein is added to a source of carbohydrate, it can provide enhanced stimulation of insulin. The level of protein is critical since protein has been shown to slow gastric emptying. U.S. Pat. No. 6,207,638 showed that when protein is added to carbohydrate in a 4 to 1 ratio, it provides increased insulin stimulation and enhances the synthesis of muscle glycogen with no negative impact on rehydration following exercise.

Sports drinks to enhance stamina have been disclosed in the prior art.

WO0139615A1 describes the use of trehalose for preparing nutritional composition, e.g., a soft drink, for consumption during or before physical exercise.

WO0117370A1 describes the oral administration of a composition containing trehalose for nutrition of patients suffering from a disorder of insulin metabolism, particularly diabetes.

WO9608979A1 describes a composition for isotonic and hypotonic sports beverages comprising an aqueous solution of trehalose having pleasant taste and producing increased blood glucose levels.

WO05013720A2 describes a dry composition for solid, semi-solid and liquid comestibles, comprises isomaltulose, polyol(s), and carbohydrate of fructose, sucrose, and/or invert sugar.

WO04084655A1 describes a dry composition for use in comestible, e.g. isotonic beverages, infant food, slimming food, comprises isomaltulose and trehalose.

WO04107883A1 describes an additive for beverage comprising normally bitter/cardboard tasting protein e.g. whey protein and trehalose to form a dehydrated mixture

WO2009085928A2 describes a sports beverage composition useful for optimizing muscle performance during exercise, comprising water, a saccharide sweetener, protein, flavoring agent, either lactic acid, phosphoric acid or an orange flavour.

WO05046360A2 describes a beverage composition for enhancing rehydration, improving fluid retention, and abating urinary loss, particularly useful for athletes, the composition comprises a carbohydrate source, sodium, chloride, potassium, and water.

None of the prior art publications disclose the nutritional composition of the present invention for enhancing endurance and performance during exercise. There is still a need for a nutritional or sports beverage composition which provides enhanced endurance and recovery from exercise, but which does not produce the drop in plasma glucose commonly found with common carbohydrate-containing compositions.

### SUMMARY OF THE INVENTION

In accordance with the present invention, nutritional compositions and methods are provided that are effective in optimizing muscle and/or exercise performance and/or endurance and/or recovery during and/or after exercise.

According to a first aspect of the invention, a nutritional composition comprises trehalose and a peptide source or a stimulant selected from caffeine or taurine, wherein the average length of the peptide(s) is from about 3 to 9 amino acids. Preferably the composition contains trehalose, the peptide(s) and the stimulant.

The sports beverage compositions disclosed herein provide for nutritional compositions for optimizing muscle performance during exercise; compositions that will speed the uptake of glucose into the muscle cells during exercise; compositions that will increase the efficiency of every gram of every carbohydrate consumed during exercise; compositions that will restore fluid and electrolytes, for replenishing glycogen stores in the muscle, and for reducing oxidative and muscle stress; compositions to speed the uptake of glycogen into the muscle thereby sparing muscle glycogen stores and extending endurance; compositions that restore fluid and electrolyte levels that are depleted during exercise; and compositions that reduce oxidative stress by preventing the build-up of free radicals that form as a consequence of exercise.

Another object of the present invention is to provide a nutritional composition that will speed the uptake of glucose into the muscle cell during exercise.

Another object of the present invention is to provide a nutritional composition for restoring fluid and electrolytes and for replenishing glycogen stores in the muscle and for reducing oxidative and muscle stress.

Another object of the present invention is to provide a nutritional composition that restores protein, fluid and electrolyte levels that are depleted during or following exercise.

Another object of the present invention is to provide a nutritional composition that reduces oxidative stress by preventing the build-up of free radicals that form as a consequence of exercise.

A further object of the invention is to provide a complete, multi-ingredient beverage composition for providing multiple nutritional benefits to a subject.

### DESCRIPTION OF THE FIGURES

The invention is described with reference to the accompanying drawings, wherein:

FIG. 1 is a boxplot showing sprint times for each session, comparing a composition according to the invention versus placebo, as described in Example 8; and

FIG. 2 is a bar graph showing energy scores derived from a visual analogue scale in subjects consuming a composition according to the invention, as described in Example 9.

### DESCRIPTION OF THE INVENTION

The present invention is based on the discovery that a combination of trehalose and a source of peptides, wherein the average length of the peptides is from about 3 to 9 amino acids, and optionally a stimulant such as taurine or caffeine, provides a rapid boost in energy which is maintained for a long period of time during exercise and which aids recovery from said exercise.

Without being bound by theory, the consumption of trehalose provides a sustained boost to blood glucose levels that lasts for considerably longer than the boost given by an equivalent molar quantity of glucose. The peptides complement the trehalose effect by being readily useable to stimulate protein synthesis, thereby maintaining or raising muscle mass and/or reducing post-exercise fatigue.

Trehalose (a-D-glucopyranosyl-a-D-glycopyranoside) is a naturally-occurring non-reducing disaccharide found in fungi, certain yeasts, certain drought resistant plants and in the blood of insects. Suitable forms or isoforms of trehalose which may be employed in the invention include hydrated crystalline trehalose, anhydrous crystalline trehalose, anhydrous amorphous trehalose, α,α-trehalose, α,β-trehalose (neo-trehalose), β,β-trehalose (iso-trehalose), or mixtures thereof. Solid dose forms of the invention may suitably comprise amorphous trehalose, anhydrous crystalline trehalose or anhydrous amorphous trehalose, or mixtures thereof, for optimizing the desiccant properties of these forms of trehalose, as disclosed in WO1997/028788, herein incorporated by reference.

The term “maintain” used herein in relation to blood glucose levels signifies that the trehalose provides a blood glucose level that is higher in a statistically significant amount than is observed for a placebo containing an equivalent amount of water and no carbohydrate. Preferably, in the use according to the present invention, the blood glucose level is maintained at a level at least 0.25 mmol/l above the level for a carbohydrate-free placebo of equal liquid volume, and more preferably at least 0.40 mmol/l above that level.

The term “maintain” used herein in relation to perceived energy levels in a subject, signifies that a composition according to the invention provides energy levels that are higher than the perceived energy levels prior to administration. Alternatively, a composition according to the invention provides perceived energy levels which are higher in a statistically significant amount than is observed for a placebo containing an equivalent amount of water and no carbohydrate or peptide source or stimulant. Preferably the perceived energy levels are increased and maintained, relative to the perceived energy level prior to administration, for at least about 90 minutes following administration, or for at least about 150 minutes after administration, or for at least about 180 minutes after administration.

Preferably, the blood glucose level is maintained for at least 90 minutes following administration, and more preferably for at least 150 minutes after administration. Preferably, a composition according to the invention is administered no more than one hour before the start of exercise, and more preferably no more than 10 minutes before the exercise, and most preferably during the exercise. In particularly preferred methods, the administration during the exercise may be in addition to administration before the start of exercise. Preferably, the blood glucose level is maintained for at least one hour following the physical exercise, and more preferably for at least 90 minutes following the physical exercise.

In a further embodiment a nutritional composition comprises trehalose and an amount of peptides, particularly di-peptides and tri-peptides. An exemplary peptide source is the spray-dried combination of casein hydrolysate and malic acid, known as PeptoPro (DSM Food Specialties BV, Delft, Netherlands) as disclosed in WO 2002/45523 and WO 02/45524, herein incorporated by reference. PeptoPro® is a protein hydrolysate derived from the casein protein fraction of cow's milk. It is rich in small peptides; ˜60% is smaller than 500 Dalton. Molecular mapping indicates that ˜7.5% is free amino acids, ˜8.5% is di-peptides, and ˜39% is tri-peptides. These di- and tri-peptides can be used immediately by the body to stimulate protein synthesis and thus have a positive influence on raising or maintaining muscle mass.

In a further embodiment the nutritional composition comprises trehalose and a protein hydrolysate, wherein the average length of the peptides in the hydrolysate is from about 3 to 9 amino acids. Preferred hydrolysates according to the invention are: a whey hydrolysate which comprises peptides wherein the molar fraction of peptides carrying a carboxy terminal proline is at least 8%, preferably at least 15%, more preferably from 30 to 70%, a casein hydrolysate which comprises peptides wherein the molar fraction of peptide carrying a carboxy terminal proline is at least 25%, preferably from 30 to 70%, and a soy hydrolysate which comprises peptides wherein the molar fraction of peptides carrying a carboxy terminal proline is at least 20%, preferably from 30 to 70%. By peptides or peptide fragments it is meant peptides with molecular masses from 400 to 2000 Dalton. These peptides can be analysed according to LC/MC analysis, as will be appreciated by the skilled person.

Exemplary vegetable proteins to be used in a composition according to the invention, either in their native state or as a hydrolysate as described above, include soy protein, soy protein isolate, soy protein concentrate, pea protein, rice protein, soy flour, rice protein, wheat protein, corn protein, nut protein, or a combination comprising at least one of the foregoing proteins. Exemplary other proteins include egg albumin, yeast concentrate, or a combination comprising at least one of the foregoing proteins.

The peptide source is generally present in the beverage composition in an amount of about 0.2 to about 10 weight percent, specifically about 1.0 to about 7.0 weight percent, and yet more specifically about 2 or 3.0 to about 5.0 weight percent based on the total weight of the composition.

In a further embodiment according to the invention is provided a nutritional composition in the form of a beverage, comprising trehalose and an amount of peptides, wherein the average length of the peptides is from about 3 to 9 amino acids, wherein the weight ratio of trehalose to said peptide source is from about 95:5 to about 5:95, or between about 10:1 to about 3:1, or between about 1:10 to about 1:3.

In an embodiment of the present invention is provided a nutritional composition comprising, trehalose, a source of peptides, wherein the average length of the peptides is from about 3 to 9 amino acids, and optionally further comprising a stimulant such as caffeine or taurine, or a combination thereof.

In a further embodiment the nutritional composition comprises, trehalose and a stimulant such as caffeine or taurine, or a combination thereof, wherein the dose of caffeine is at least from about 3 mg/kg or more, or from about 5 mg/kg or more, or from about 6 mg/kg or more.

In a yet further embodiment the nutritional composition comprises, trehalose, a source of peptides, wherein the average length of the peptides is from about 3 to 9 amino acids, and optionally further comprising a stimulant such as caffeine or taurine, or a combination thereof, wherein the dose of caffeine is at least from about 3 mg/kg or more, or from about 5 mg/kg or more, or from about 6 mg/kg or more.

In another embodiment there is the use of a combination of trehalose and a source of peptides, wherein the average length of the peptides is from about 3 to 9 amino acids, and optionally a stimulant such as caffeine or taurine, or a combination thereof, for the preparation of a nutritional composition for oral administration to a subject during and/or shortly before prolonged physical exercise to reduce physical and mental impairment of the subject during and/or following said exercise.

In another embodiment there is the use of a combination of trehalose and a source of peptides, wherein the average length of the peptides is from about 3 to 9 amino acids, and optionally a stimulant such as caffeine or taurine, or a combination thereof, for the preparation of a nutritional composition for oral administration to a subject during and/or shortly before prolonged physical exercise to promote post-exercise recovery.

In embodiments providing a packaged ready-to-drink beverage, the beverage composition may be pre-mixed with, or dissolved in a liquid such as water, preferably spring water. In certain embodiments, the ready-to-drink beverage comprises about 80-99 weight percent (wt %) of liquid of the total weight of the beverage. Unless otherwise specified, all weight percentages are based on the total weight of a ready-to-drink beverage. In further embodiments, the beverage composition can be packaged as an edible composition or concentrate, such as a dry mix (e.g., powder) or a liquid concentrate for later reconstitution with one or more liquids to form a beverage. The concentrated composition may be associated with instructions for preparing the beverage composition. In another embodiment, a beverage concentrate may be packaged as a gel, sachet, capsule, or tablet which is consumed with liquid. When provided in these forms, the beverage composition may comprise instructions to mix or consume with an amount of liquid which is equal to about 80-99 wt % of the prepared beverage composition.

A particularly preferred presentation of the invention is as a shot or pouch. A shot is a small, unit dose sealed presentation, preferably comprising between about 5 ml and about 500 ml or between about 50 and about 200 ml of the beverage composition of the invention. A pouch presentation, such as a doypack, cheerpack, gualapack and the like, may contain between 50 and 500 ml of the beverage composition of the invention.

In general, a rehydration/sports beverage in accordance with this disclosure typically comprises at least water, one or more carbohydrates comprising trehalose, electrolytes, acidulent and flavouring. Exemplary flavourings which may be suitable for at least certain formulations in accordance with this disclosure include citrus flavouring, spice flavourings and others. Preservatives can be added if desired, depending upon the other ingredients, production technique, desired shelf-life, etc. Additional and alternative suitable ingredients will be recognized by those skilled in the art given the benefit of this disclosure.

In an embodiment a nutritional composition comprises, trehalose, a source of peptides, wherein the average length of the peptides is from about 3 to 9 amino acids, and optionally further comprising a stimulant such as caffeine or taurine, or a combination thereof, and optionally further comprising a carbohydrate additive chosen from tagatose, galactose, rhamnose, acyclodextrin, maltodextrin (including resistant maltodextrins such as Fibersol), dextran, sucrose, glucose, ribulose, fructose, threose, arabinose, xylose, lyxose, allose, altrose, mannose, idose, lactose, maltose, invert sugar, palatinose or isomaltulose, erythrose, deoxyribose, gulose, idose, talose, erythrulose, xylulose, psicose, turanose, cellobiose, amylopectin, glucosamine, mannosamine, fucose, glucuronic acid, gluconic acid, glucono-lactone, abequose, galactosamine, beet oligosaccharides, isomalto-oligosaccharides (isomaltose, isomaltotriose, panose and the like), xylo-oligosaccharides (xylotriose, xylobiose and the like), gentio-oligoscaccharides (gentiobiose, gentiotriose, gentiotetraose and the like), sorbose, nigero-oligosaccharides, fucose, fructooligosaccharides (kestose, nystose and the like), maltotetraol, maltotriol, malto-oligosaccharides (maltotriose, maltotetraose, maltopentaose, maltohexaose, maltoheptaose and the like), lactulose, melibiose, raffinose, rhamnose, ribose, isomerized liquid sugars such as high fructose corn/starch syrup (e.g., HFCS55, HFCS42, or HFCS90), coupling sugars, soybean oligosaccharides, or glucose syrup.

In another embodiment the nutritional composition comprises, trehalose, a source of peptides, wherein the average length of the peptides is from about 3 to 9 amino acids, and optionally further comprising a stimulant such as caffeine or taurine, or a combination thereof, and optionally further comprising a polyol additive chosen from erythritol, maltitol, mannitol, sorbitol, lactitol, xylitol, inositol, isomalt, propylene glycol, glycerol (glycerine), threitol, galactitol, reduced isomalto-oligosaccharides, reduced xylo-oligosaccharides, reduced gentio-oligosaccharides, reduced maltose syrup, or reduced glucose syrup.

In another embodiment the nutritional composition comprises, trehalose, a source of peptides, wherein the average length of the peptides is from about 3 to 9 amino acids, and optionally further comprising a stimulant such as caffeine or taurine, or a combination thereof, and optionally further comprising an amino acid additive chosen from aspartic acid, arginine, glycine, glutamic acid, proline, threonine, theanine, cysteine, cystine, alanine, valine, tyrosine, leucine, isoleucine, asparagine, serine, lysine, histidine, ornithine, methionine, carnitine, aminobutyric acid (alpha-, beta-, and gamma-isomers), glutamine, hydroxyproline, taurine, norvaline, sarcosine, or salts thereof.

In an other embodiment the nutritional composition comprises, trehalose, a source of peptides, wherein the average length of the peptides is from about 3 to 9 amino acids, and optionally further comprising a stimulant such as caffeine or taurine, or a combination thereof, and optionally further comprising a sugar acid additive chosen from aldonic, uronic, aldaric, alginic, gluconic, glucuronic, glucaric, galactaric, galacturonic, or salts thereof.

In another embodiment of the present invention is provided a nutritional composition comprising, trehalose, a source of peptides, wherein the average length of the peptides is from about 3 to 9 amino acids, and optionally further comprising a stimulant such as caffeine or taurine, or a combination thereof, and optionally further an organic acid additive chosen from C2-C30 carboxylic acids, substituted hydroxyl C1-C30 carboxylic acids, benzoic acid, substituted benzoic acids (e.g., 2,4-dihydroxybenzoic acid), substituted cinnamic acids, hydroxyacids, substituted hydroxybenzoic acids, substituted cyclohexyl carboxylic acids, tannic acid, lactic acid, tartaric acid, citric acid, gluconic acid, glucoheptonic acids, glutaric acid, creatine, adipic acid, hydroxycitric acid, malic acid, fruitaric acid, fumaric acid, maleic acid, succinic acid, chlorogenic acid, salicylic acid, caffeic acid, bile acids, acetic acid, ascorbic acid, alginic acid, erythorbic acid, polyglutamic acid, or salts thereof.

In another embodiment the nutritional composition comprises, trehalose, a source of peptides, wherein the average length of the peptides is from about 3 to 9 amino acids, and optionally further comprising a stimulant such as caffeine or taurine, or a combination thereof, and optionally further comprising an inorganic acid additive chosen from phosphoric acid, phosphorous acid, polyphosphoric acid, hydrochloric acid, sulphuric acid, carbonic acid, sodium dihydrogen phosphate, or salts thereof.

In another embodiment of the present invention is provided a nutritional composition comprises, trehalose, a source of peptides, wherein the average length of the peptides is from about 3 to 9 amino acids, and optionally further comprising a stimulant such as caffeine or taurine, or a combination thereof, and optionally further comprising a sweet taste improving bitter compound additive chosen from, quinine, urea, bitter orange oil, naringin, quassia, or salts thereof.

In another embodiment the nutritional composition comprises, trehalose, a source of peptides, wherein the average length of the peptides is from about 3 to 9 amino acids, and optionally further comprising a stimulant such as caffeine or taurine, or a combination thereof, and optionally further a flavourant additive chosen from vanillin, vanilla extract, mango extract, cinnamon, citrus, coconut, ginger, viridiflorol, almond, menthol, grape skin extract, or grape seed extract. Suitable sweet taste improving polymer additives include from chitosan, pectin; pectic, pectinic, polyuronic, polygalacturonic acid; starch, food hydrocolloid or crude extracts thereof (e.g., gum acacia Senegal, gum acacia seyal, carageenan), poly-L-lysine, polypropylene glycol, polyethylene glycol, poly(ethylene glycol methyl ether), polyarginine, polyaspartic acid, polyglutamic acid, polyethyleneimine, alginic acid, sodium alginate, propylene glycol alginate, sodium polyethyleneglycolalginate, sodium hexametaphosphate and its salts, or other cationic and anionic polymers.

In a preferred embodiment the nutritional composition is in the form of a beverage, comprising trehalose and an amount of peptides, wherein the average length of the peptides is from about 3 to 9 amino acids, optionally further comprising a stimulant such as caffeine or taurine, or a combination thereof, without the presence of artificial preservatives.

The term “beverage”, as used herein, means a drinkable composition. Beverages include, but are not limited to the following: carbonated and non-carbonated, alcoholic and non-alcoholic drinks including but not limited to carbonated water, flavoured water, carbonated flavoured water, drinks containing juice (juice derived from any fruit or any combination of fruits, juice derived from any vegetable or any combination of vegetables, such as beet root and the like) or nectar, vitamin-enhanced sports drinks, high electrolyte sports drinks, highly caffeinated high energy drinks, coffee, decaffeinated coffee, tea, tea derived from fruit products, tea derived from herb products, decaffeinated tea, wine, champagne, malt liquor, rum, gin, vodka, other hard liquors, milk obtained from animals, milk product derived from soy, rice, coconut or other plant material, sports drinks, beer, reduced calorie beer-type beverages, non-alcoholic beer, and other beer-type beverages obtained from a cereal solution such as beer, ale, stout, lager, porter, low alcoholic beer, alcohol-free beer, kvass, rye-bread beer, shandy, malt drinks and the like. Cereal in this context refers to grains commonly used to make the beverages listed above and other similar beverages. However, the term “beverage” excludes 100% juice based-beverages.

Preferably, the beverage composition also comprises at least one salt, optionally in an amount sufficient to enhance uptake of the water through the gastrointestinal tract.

Fluid replacement after significant dehydration is driven by various physiological changes. The two major physiological drivers that encourage voluntary drinking are plasma osmolality and plasma volume. During exercise, the loss of fluid through sweat causes plasma volume to drop and plasma osmolality to increase. These physiological changes cause a thirst response which drives voluntary fluid consumption. Scientific studies have shown that sodium also plays an important role in regulating plasma volume and osmolality.

Ingesting beverages containing sodium helps increase the rate at which plasma volume and osmolality return to normal. However, ingesting too high a level of sodium causes rapid restoration of plasma volume, which reduces the drinking response and prevents adequate rehydration. In addition, the sensory properties of a beverage containing too high a level of sodium are unfavourable, and would further reduce the drive to drink. (Wemple, Richard D., Morocco, Tamara S., Mack, Gary W., Influence of Sodium Replacement on Fluid Ingestion Following Exercised-Induced Dehydration, Intl J. Sport Nutrition & Exerc Metabolism 7: 104-116 (1997)). This article is hereby incorporated by reference.

It is further believed that other electrolytes and minerals play an important role in rehydration by possibly affecting fluid replacement and fluid retention. In response to fluid loss during dehydration, water is distributed between fluid compartments so that both the extracellular and intracellular compartments share the water deficit. Sodium, potassium, magnesium, calcium and chloride are some of the more important electrolytes/minerals involved in filling these body fluid compartments, particularly sodium, chloride, potassium and magnesium. Beverages providing sodium and chloride encourage the filling of the extracellular compartment, while beverages providing potassium, magnesium, and calcium favour the filling of the intracellular compartment. Properly balancing the sodium, potassium, magnesium, calcium and chloride levels will further improve the rehydration properties of the beverage.

These electrolyte ions assist in filling these body fluid compartments more rapidly and help to retain the fluid instead of it being excreted as urine. Since both sodium and chloride ions favour the filling of the extracellular compartments, substitution of one with the other may not affect the overall result. The same may be true for potassium and magnesium in regards to intracellular hydration.

In another embodiment the nutritional composition comprising a combination of trehalose and a source of peptides, wherein the average length of the peptides is from about 3 to 9 amino acids, optionally further comprising a stimulant such as caffeine or taurine, or a combination thereof; and/or an electrolyte selected from sodium, chloride, potassium, magnesium, and/or calcium, or a combination thereof, for oral administration to a subject during and/or shortly before prolonged physical exercise to reduce physical and mental impairment of the subject during and/or following said exercise.

In another aspect, the nutritional composition comprising a combination of trehalose and a source of peptides, wherein the average length of the peptides is from about 3 to 9 amino acids; optionally further comprising a stimulant such as caffeine or taurine, or a combination thereof, and/or an electrolyte selected from sodium, chloride, potassium, magnesium, and/or calcium, or a combination thereof, is for oral administration to a subject during and/or shortly before prolonged physical exercise to promote post-exercise recovery.

Electrolytes such as sodium, calcium, potassium magnesium and or calcium compounds are used within the nutritional composition for replenishing the electrolytes lost during exercise, for facilitating intestinal reabsorption of fluids, and for facilitating energy dependent processes. A first electrolyte being sodium compounds include sodium chloride, sodium acetate, acidic sodium citrate, acidic sodium phosphate, sodium bicarbonate, sodium bromide, sodium citrate, sodium lactate, sodium phosphate, anhydrous sodium sulphate, sodium sulphate, sodium tartrate, sodium benzoate and sodium selenite. A second electrolyte being potassium compounds include potassium chloride, potassium acetate, potassium bicarbonate, potassium bromide, potassium citrate, potassium-D-gluconate, monobasic potassium phosphate, potassium tartrate, potassium sorbate and potassium iodide. A third electrolyte being magnesium compounds include magnesium chloride, magnesium oxide, magnesium sulphate, magnesium carbonate, magnesium aspartate and magnesium silicate. Preferably, the salt is selected from the group consisting of salts of sodium, potassium, magnesium and or calcium, or a combination or mixture thereof. Preferably, any one of such salts may be present in an amount of from about 1 or 10 to about 300 mmol/l, or from about 10 or 20 to about 150 mmol/l.

More specifically, the sodium content of the composition of the present invention comprises at least about 30 mEq/L, preferably from about 30 to about 100 mEq/L of beverage, more preferably from about 30 to about 60 mEq/L of beverage, even more preferably from about 33 to about 40 mEq/L. This sodium concentration indicates the total amount of sodium present in the beverage, including sodium contained in the carbohydrate source, flavouring agent (to the extent known), and clouding agent. For example, maltodextrin as a carbohydrate source may contain sodium. However, these sources alone cannot raise the sodium levels of the beverage to the necessary levels, and as such additional sodium must be added from another sodium ion source. Any source of sodium known to be useful to those skilled in the art can be used in the present invention. Examples of useful sodium sources include, but are not limited to, sodium chloride, sodium citrate, sodium bicarbonate, sodium lactate, sodium pyruvate, sodium acetate and mixtures thereof.

In one embodiment, a mixture of sodium chloride and sodium citrate is preferred, and a mixture of from about 10 to about 50 mEq/L, preferably from about 10 to about 30 mEq/L, and more preferably from about 10 to about 20 mEq/L of sodium from sodium chloride and from about 10 to about 50 mEq/L, preferably from about 10 to about 30 mEq/L, and more preferably from about 10 to about 20 mEq/L of sodium from sodium citrate.

A mEq/L is a milliequivalent which is defined as the concentration of substance per liter of solution, calculated by dividing the concentration in milligrams per 100 milliliters by the molecular weight.

In addition, the composition of the present invention also includes chloride. The chloride ion can come from various sources known to those skilled in the art. Examples of chloride sources include, but are not limited to, sodium chloride, potassium chloride, magnesium chloride and mixtures thereof. The concentration of chloride is at least about 10 mEq/L, preferably from about 10 to about 20 mEq/L, more preferably from about 11 to about 18 mEq/L of chloride from sodium chloride.

The composition of the present invention also includes potassium. The potassium ion source can come from many sources known to those skilled in the art as being useful in the present invention. Examples of potassium sources useful herein include, but are not limited to, potassium monophosphate, potassium diphosphate, potassium chloride, and mixtures thereof, with potassium monophosphate being preferred. The potassium content is at least 8 mEq/L, preferably from about 8 to about 20, and more preferably at from about 10 to about 19 mEq/L.

The composition of the present invention further preferably includes magnesium. The magnesium ion can also come from many sources known to those skilled in the art. Examples of magnesium sources include, but are not limited to, magnesium oxide, magnesium acetate, magnesium chloride, magnesium carbonate, magnesium diphosphate, magnesium triphosphate, magnesium in the form of an amino acid and mixtures thereof, with magnesium oxide being preferred. The concentration of magnesium is at a level of at least 0.1 mEq/L, preferably from about 0.5 to about 6 mEq/L, more preferably from 1 to 3 mEq/L.

Additionally, calcium preferably is present in the composition of the present invention. The calcium ion may come from a variety of sources known to those skilled in the art. Examples include but are not limited to, calcium lactate, calcium carbonate, calcium chloride, calcium phosphate salts, calcium citrate and mixtures thereof, with calcium lactate being preferred. Calcium is present at a concentration of at least 0.1 mEq/L, preferably from about 0.5 to about 6 mEq/L, more preferably from 1 to 3 mEq/L.

In addition to trehalose and salts, the composition according to the invention may contain other nutrients. Suitable nutrients include monosaccharides such as fructose, mannose, galactose and glucose, and disaccharides other than trehalose such as sucrose, maltose and lactose. Suitable nutrients further include vitamins, minerals, amino acids, peptides and proteins. Suitable vitamins include vitamin C, the B vitamins, pantothenic acid, thiamin, niacin, niacinamide, riboflavin and biotin. Suitable minerals include iron, zinc, chromium, calcium, copper and magnesium. Suitable amino acids include the 20 amino acids utilised by humans.

The compositions may further include appropriate amounts of colouring, artificial and natural flavours, sweeteners and preservatives. The compositions may further include one or more stimulants such as taurine and caffeine. Preferably, the beverage compositions do not contain any artificial colours, flavours, sweeteners or preservatives. Suitable natural preservatives for use in liquid compositions according to the invention include rosemary extracts comprising carnosic, rosemarinic and ursolic acid. Suitable sweeteners include dihydrochalcones, monatin, monellin, steviosides, glycyrrhizin, or dihydroflavenol.

In accordance with the present invention, the step of oral administration preferably comprises administration of at least 0.1 g of trehalose per kg body weight of the person, preferably at least 0.3 g/kg and more preferably at least 0.5 g/kg. Preferably, the step of oral administration comprises administration of a unit dose containing more than about 2 g of trehalose to the human subject, or at least about 5 g, or about 10 g or about 20 g or at least about 25 g. The total dose per day may be at least about 10 g or about 20 g or at least about 25 g or at least about 40 g per day, or more.

Preferably, the nutritional composition is in a unit dosage format. That is say it is in a form adapted for consumption by a single human subject at substantially one time, for example a confectionery bar, an energy or cereal bar, or a bottle, pouch or can containing about 100-500 ml of beverage. Preferably, the unit dosage form contains more than about 6 g of trehalose, or more than about 12 g of trehalose, or more preferably about 20 g of trehalose. Preferably, the nutritional composition is packaged in the unit dosage format.

Preferably, the physical exercise is vigorous exercise, and more preferably the physical exercise is exercise substantially to exhaustion. Suitable forms of exercise include running, football, rugby, cycling, jogging, biathlons, triathlons, marathons, tennis, basketball, squash, housework, dancing and the like. Preferably, the duration of the exercise is at least 20 minutes, more preferably 30 minutes or more.

Other component constituents of the composition include flavour components and/or colorant components. The flavour component for the nutritional composition of the present invention is provided to impart a particular and characteristic taste and sometimes an aroma to the nutritional composition. The use of a flavour component in the nutritional composition also provides an enhanced aesthetic quality to the nutritional composition which will increase the user's appeal in using the product. The flavour component suitable for inclusion in a composition according to the invention may be selected from the group consisting of water-soluble natural or artificial extracts that include apple, banana, cherry, cinnamon, cranberry, grape, honeydew, honey, kiwi, lemon, lime, orange, peach, peppermint, pineapple, raspberry, tangerine, watermelon., wild cherry, and equivalents and combinations thereof.

Specific flavouring agents for use in a sports beverage composition of the invention include those flavouring agents that can impart a complementary character flavour to the off-notes provided by the source of peptides. Specifically, use of a tropical fruit flavour (e.g., grapefruit flavour) which has a sulphur note can be used to complement the sulphur off-note of the source of peptides.

In another embodiment, the sports beverage composition comprises a grapefruit flavour, a peach flavour, a dark berry flavour, or a fruit punch flavour.

In yet another embodiment, the sports beverage composition comprises an orange flavour note. The orange flavour note can be low in orange terpenes.

A beverage composition of the present invention typically includes from about 4% to about 10%, preferably from about 5.5% to about 6.5%, more preferably about 6% by weight of a carbohydrate source. Carbohydrate sources, preferably includes trehalose, maltotetraose, galactose, fructo-oligosaccharides, beta-glucan, and kioses such as pyruvate and lactate, and combinations thereof.

In one embodiment, a mixture of a minimum of two of these is employed. A preferred composition of carbohydrates comprises from about 1:9 to 1:2 maltotetraose:trehalose, to produce a total of about 4% to 6% by weight carbohydrates.

In another embodiment, a preferred composition of carbohydrates comprises from about 1:9 to 1:2 palatinit:trehalose, to produce a total of about 4% to 6% by weight carbohydrates.

In one embodiment, the beverage of the present invention is formulated to have an osmolality, when initially formulated, in the range of from about 220 to about 380 mOsm/Kg of beverage, and is preferably in the range of from about 250 to about 330, more preferably from about 260 to about 320 mOsm/Kg of beverage. As such, when prepared, the beverages of this embodiment are isotonic. The scientific and strict definition of the term isotonic is a solution that has the same or nearly the same osmotic pressure as another solution, typically human blood. Although the beverages of the present invention can be isotonic when prepared, even with regards to the strict scientific meaning of the term, the term isotonic as presently used is not meant to be so narrowly defined. With respect to the present specification, isotonic is meant to refer to the fact that the beverages of the present invention are sports-type beverages which contain a certain amount of carbohydrates and electrolytes.

In other embodiments of the invention, the beverage composition may be hypotonic or hypertonic.

The beverage composition may be a clear solution, but can be coloured.

The beverage of the present invention may also include a clouding agent at a concentration range of from about 0 to about 100 ppm of clouding agent. Examples of clouding agents include, but are not limited to, ester gum, SAIB, starch components and mixtures thereof, with ester gum as the preferred clouding agent at a concentration range of from about 10 to about 50 ppm and more preferably from about 15 to about 35 ppm.

The beverage of the present invention may further include a food-grade acid at a concentration range of from about 0.001% to about 2%, or about 0.024% to about 0.75% by weight. Suitable food-grade acids for use in the composition include, for example, acetic acid, adipic acid, ascorbic acid, butyric acid, citric acid, formic acid, fumaric acid, glyconic acid, lactic acid, malic acid, phosphoric acid, oxalic acid, succinic acid, tartaric acid, and a combination comprising at least one of the foregoing food-grade acids. The food-grade acid can be added as acidulant to control the pH of the beverage and also to provide some preservative properties; or to stabilize the beverage. Such food-grade acid lowers the pH in order to insure it is a high acid beverage which may be pasteurized under conditions less harsh than required for low acid beverages. Beverages of the present invention preferably have a pH of from about 2.5 to about 6.5, preferably from about 2.75 to about 4.5, more preferably from about 2.9 to about 4.0. In addition, citric acid and the like adds tartness to the beverage.

The present invention also relates to a beverage concentrate used to prepare the beverage already described herein. As used herein, the term “beverage concentrate” refers to a concentrate that is either in liquid or gel form or in essentially dry mixture form. The essentially dry mixture is typically in the form of a powder, although it may also be in the form of a single-serving tablet, or any other convenient form. The concentrate is formulated to provide a final and complete beverage as already described herein when constituted or diluted with water or other liquid.

In further embodiments, the composition may include optional additives such as antioxidants, amino acids, caffeine, colouring agents (“colorants”, “colourings”), emulsifiers, flavour potentiators, food-grade acids, minerals, micronutrients, plant extracts, phytochemicals (“phytonutrients”), preservatives, salts including buffering salts, stabilizers, thickening agents, medicaments, vitamins, and a combination comprising at least one of the foregoing additives. Those of ordinary skill in the art will appreciate that certain additives may meet the definition or function according to more than one of the above-listed additive categories.

Particularly preferred nutritional compositions according to the invention comprise, trehalose and satiety-inducing ingredients, such as palm and oat oil emulsion (Fabuless, DSM), fibers such as fructo-oligosaccharide and/or inulin, and/or Yerba Mate, Damiana, Guarana, (Zotrim),

In a further embodiment of the invention, the beverage composition typically includes from about 4% to about 10%, preferably from about 5.5% to about 6.5%, more preferably about 6% by weight of a carbohydrate source, optionally further comprising antioxidants, and/or amino acids, and/or caffeine, and/or food-grade acids, and/or minerals, and/or micronutrients, and/or plant extracts, and/or phytochemicals (“phytonutrients”), and/or preservatives, and/or salts including buffering salts, and/or stabilizers, and/or thickening agents, and/or medicaments, and/or vitamins, and a combination comprising at least one of the foregoing additives.

In another preferred embodiment of the invention, a lifestyle drink or snack for the elderly comprises trehalose, gingko and/or other cognitive enhancing additives such as green tea, and the like.

In another preferred embodiment of the invention, the beverage composition preferably further comprises omega-3 and/or omega-6 fatty acids.

In yet another preferred embodiment of the invention, the beverage composition preferably further comprises pullulan as a source of energy and/or prebiotic fibre.

In yet another preferred embodiment of the invention, the beverage composition preferably further comprises a source of antioxidant, preferably polyphenols.

In another preferred embodiment of the invention, the beverage composition preferably comprises trehalose and omega-3 and/or omega-6 fatty acids, and optionally further comprises cognitive enhancing additives such as green tea extract and/or L-theanine and/or phosphatidyl serine and/or acetyl carnitine and/or CDP-choline, and the like.

In another preferred embodiment of the invention, the beverage composition preferably comprises trehalose and omega-3 and/or omega-6 fatty acids, and optionally further comprises glucosamine and its salts, and/or natural egg shell membrane.

Emulsifiers can be added to the composition to prevent separation of the composition components by keeping ingredients dispersed. Emulsifiers can include molecules which have both a hydrophilic part and a hydrophobic part. Emulsifiers can operate at the interface between hydrophilic and hydrophobic materials of the beverage to prevent separation of the components of the composition. Suitable emulsifiers for use in the compositions include, for example, lecithin (e.g., soy lecithin); mono and di-glycerides of long chain fatty acids, specifically saturated fatty acids, and more specifically, stearic and palmitic acid mono- and diglycerides; mono and di-glycerides of acetic acid, citric acid, tartaric acid, or lactic acid; egg yolks; polysorbates (e.g., polysorbate 20, polysorbate 40, polysorbate 60, polysorbate 65, and polysorbate 80), propylene glycol esters (e.g, propylene glycol monostearate); propylene glycol esters of fatty acids; sorbitan esters (e.g., sorbitan monostearates, sorbitan tristearates, sorbitan monolaurate, sorbitan monooleate), Acacia (gum arabic), sucrose monoesters; polyglycerol esters; polyethoxylated glycerols; and the like, and a combination comprising at least one of the foregoing emulsifiers.

Certain components (sometimes referred to as hydrocolloids) that act as thickening agents which can impart added “mouth-feel” to the composition include natural and synthetic gums, for example locust bean gum, guar gum, gellan gum, xanthan gum, gum ghatti, modified gum ghatti, tragacanth gum, carrageenan, and the like; natural and modified starches, for example pregelatinized starch (corn, wheat, tapioca), pregelatinized high amylose-content starch, pregelatinized hydrolyzed starches (maltodextrins, corn syrup solids), chemically modified starches such as pregelatinized substituted starches (e.g., octenyl succinate), and the like; cellulose derivatives, for example carboxymethylcellulose, sodium carboxymethylcellulose, and the like; polydextrose; whey or whey protein concentrate; pectin; gelatin; and a combination comprising at least one of the foregoing thickening agents.

Preservatives, including antimicrobials, can be added to the composition to provide freshness and to prevent the unwanted growth of bacteria, moulds, fungi, or yeast. The addition of a preservative, including antioxidants, may also be used to maintain the composition's colour, flavour, or texture. Any suitable preservatives for use in food and beverage products can be incorporated into the compositions. Examples of suitable preservatives include benzoic acid alkali metal salts (e.g., sodium benzoate), sorbic acid alkali metal salts (e.g., potassium sorbate), ascorbic acid (Vitamin C), citric acid, calcium propionate, sodium erythorbate, sodium nitrite, calcium sorbate, butylatedhydroxyanisole (BHA), butylatedhydroxytoluene (BHT), ethylenediaminetetraacetic acid (EDTA), tocopherols (Vitamin E), straight chain polyphosphates, and a combination comprising at least one of the foregoing preservatives. The composition can contain the preservative or preservative combination in an amount of about 0.01% to about 0.50%, specifically about 0.02% to about 0.30%, more specifically about 0.03% to about 0.10%; and yet more specifically about 0.05 to about 0.08 wt % each based on the total weight of the composition or unit dosage form.

The beverage composition can further comprise Vitamin E in the range of about 0.005 to about 0.01 weight percent of beverage composition for use as an antioxidant for preventing free radical formation during exercise. Suitable vitamins or vitamin precursors include ascorbic acid (Vitamin C), beta carotene, niacin (Vitamin B3), riboflavin (Vitamin B2), thiamin (Vitamin B1), niacinamide, folate or folic acid, alpha tocopherols or esters thereof, Vitamin D, retinyl acetate, retinylpalmitate, pyridoxine (Vitamine B6), folic acid (Vitamin B9), cyanocobalimin (Vitamin B12), pantothenic acid, biotin, and a combination comprising at least one of the foregoing vitamins. In some embodiments, vitamins or vitamin precursors can include fat soluble vitamins such as vitamin A, vitamin D, vitamin E, and vitamin K, and a combination comprising at least one of the foregoing vitamins. In some embodiments, vitamins or vitamin precursors can include water soluble vitamins such as vitamin C (ascorbic acid), the B vitamins (thiamine or B1, riboflavoin or B2, niacin or B3, pyridoxine or B6, folic acid or B9, cyanocobalamin or B1, pantothenic acid, biotin), and a combination comprising at least one of the foregoing vitamins. The amount of vitamins or minerals provided in the compositions can be up to or exceeding amounts generally recognized as U.S. Recommended Daily amounts or the Recommended Daily Intake amounts established by the U.S. Food and Drug Administration.

In some embodiments exemplary micronutrients can include L-carnitine, choline, coenzyme Q10, alpha-lipoic acid, omega-3-fatty acids (preferably long-chain polyunsaturated fatty acids), pepsin, phytase, trypsin, lipases, proteases, lactotripeptide, Isoleucine-Proline-Proline (IPP), cellulases, and a combination comprising at least one of the foregoing.

Antioxidants can include materials that scavenge free radicals. In some embodiments, exemplary antioxidants can include citric acid, rosemary oil, vitamin A, vitamin E, vitamin E phosphate, tocopherols, di-alpha-tocopheryl phosphate, tocotrienols, alpha lipoic acid, dihydrolipoic acid, xanthophylls, beta cryptoxanthin, lycopene, lutein, zeaxanthin, astaxanthin, beta-carotene, carotenes, mixed carotenoids, resveratrol, polyphenols (preferably from cocoa), flavonoids, and a combination comprising at least one of the foregoing antioxidants.

Exemplary nutrients can also include amino acids such as L-tryptophan, L-lysine, L-leucine, L-methionine, 2-aminoethanesulfonic acid (taurine), and L-carnitine; creatine; glucuronolactone; inositol; and a combination comprising at least one of the foregoing nutrients.

Phytochemicals (“phytonutrients”) are plant derived compounds which may provide a beneficial effect on the health or well-being of the consumer. Phytochemicals include plant derived antioxidants, phenolic compounds including monophenols and polyphenols, and the like. Exemplary phytochemicals include lutein, lycopene, carotene, anthocyanin, capsaicinoids, flavonoids, hydroxycinnamic acids, isoflavones, isothiocyanates, monoterpenes, chalcones, coumestans, dihydroflavonols, flavanoids, flavanols, quercetin, flavanones, flavones, flavan-3-ols (catechins, epicatechin, epigallocatechin, epigallocatechingallate, and the like), flavonals (anthocyanins, cyanidine, and the like); phenolic acids; phytosterols, saponins, terpenes (carotenoids), and a combination comprising at least one of the foregoing phytochemicals.

The composition can comprise superfruits. Such superfruits may be added to the composition of the invention in dried, pureed, concentrated or extracted form. Extracts of certain superfruits have substantial antioxidant and other health benefits. These superfruits have exceptional nutrient richness and antioxidant quality with appealing taste. Nonlimiting examples of Superfruits include Acai, Blueberry, Cranberry, Grape, Guarana, Mangosteen, Noni, Pomegranate (Punica granatum), Seabuckthorn, Wolfberry (Goji), acerola (Barbados cherry, Malpighia emarginata, Malpighia glabra), bayberry (yumberry, Myrica rubra), bilberry (Vaccinium myrtillus), black raspberry (Rubus occidentalis), black chokeberry (“aronia”, Aronia melanocarpa), blackcurrant (Ribes nigrum), camucamu (Myrciaria dubia), sour (tart) cherry (Prunus cerasus), cupuacu (Theobroma grandiflorum), durian (Durio kutejensis), elderberry (Sambucus canadensis, Sambucus nigra), red guava (Psidium guajava, many species), Indian gooseberry (amalaka, amla, Phyllanthus emblica), kiwifruit (Actinidia deliciosa), lingonberry (Vaccinium vitis-idaea), lychee (Litchi chinensis), muscadine grape (Vitis rotundifolia), papaya (Carica papaya), pomelo (Citrus maxima), saskatoon berry (Amelanchier alnifolia, Nutt), tamarind (Tamarindus indica), wild cherry (Prunus avium) andyuzu (Citrus ichangensis, C. reticulata) and combinations thereof. The composition can comprise a super fruit present in a concentration of at least about 0.01%, alternatively from about 0.01% to about 10 or 20% or more, and alternatively from about 0.2% to about 5% or 10% by weight of the composition. The composition can comprise from about 0.1 mg to about 5000 mg, alternatively from about 1 mg to 3000 mg, or from about 10 mg to about 2000 mg, and alternatively from about 50 mg to about 1000 mg of a superfruit extract, per dosage unit.

The phytochemicals can be provided in substantially pure or isolated form or in the form of natural plant extracts. Suitable plant extracts which contain one or more phytochemicals include fruit skin extracts (grape, apple, crab apple, and the like), green tea extracts, white tea extracts, green coffee extract, and a combination comprising at least one of the foregoing extracts.

Various herbals, aromatic plants or plant parts or extracts thereof, can also be included in the compositions for a variety of reasons such as for flavour or for their potential health benefits. Exemplary herbals include Echinacea, Goldenseal, Calendula, Rosemary, Thyme, Kava Kava, Aloe, Blood Root, Grapefruit Seed Extract, Black Cohosh, Ginseng, Guarana, Cranberry, Ginkgo Biloba, St. John's Wort, Evening Primrose Oil, Yohimbe Bark, Green Tea, Ma Huang, Maca, Bilberry, extracts thereof, and a combination comprising at least one of the foregoing herbals. The composition of the present invention may comprise Vitamin C. When Vitamin C is present, the composition comprises from about 60 mg to about 2000 mg of Vitamin C, per dose of composition, alternatively from about 80 mg to about 1500 mg of Vitamin C, per dose of composition, alternatively from about 100 mg to about 1000 mg of Vitamin C, per dose of composition. The composition may comprise from about 0.024% to about 99% of Vitamin C, alternatively from about 0.032% to about 99% of Vitamin C, alternatively from about 0.040% to about 99% of Vitamin C, by weight of the composition.

The composition of the present invention comprises Vitamin D. Non-limiting examples of Vitamin D suitable for use in the present invention includes Vitamin D3 (cholecalciferol), Vitamin D2 (ergocalciferol) and combinations thereof. Additional, nonlimiting examples also include metabolites of Vitamin D, including calcidiol, calcitriol, and combinations thereof. The Vitamin D, including cholecalciferol, ergocalciferol, calcidiol and calcitriol, may be derived from synthetic or natural sources. Vitamin D, including cholecalciferol and calcitriol, may be sourced from an extract of solanum glaucophyllum (malacoxylon), trisetum flavescens (goldhafer) or cestrum diurnum. Both the pure, Vitamin D and/or glycosides of the Vitamin D, may be used.

In some embodiments, the beverage composition is hot-filled into the desired beverage container. More specifically, the beverage composition is filled into the beverage container at temperatures sufficient to sterilize the composition in the container, for example about 85° C. After several minutes, the container and composition can be cooled down to about 32° C. to about 38° C.

In other embodiments, the beverage composition is cold-filled into a desired beverage container. In such embodiments, preservatives can be added to the beverage composition. More specifically, cold-filling the beverage involves adding the beverage to the beverage container at ambient temperature (e.g., about 21° C.). Preservatives, such as those described herein, can be added to the composition to lower the pH level of the composition. Desirable pH values can be about 3 to about 4.5. Cold-filling with preservatives is used in some embodiments as an alternative to pasteurization.

In some embodiments, aseptic processes can be used to provide shelf-stable, sterile beverages without the use of preservatives. The aseptic process involves sterilizing the beverage composition using an ultra-high temperature process that rapidly heats, then cools, the beverage composition. The time for sterilization can be about 3 to about 15 seconds at temperatures of about 195° F. (90.6° C.) to about 285° F. (140.6° C.). The sterilized beverage composition is then filled into sterilized aseptic packages within a sterile environment. Preferred heating regimens include HTST and particularly UHT, e.g. 1 to 30 seconds at a temperature of between 60° C. and 100° C., more preferably between about 3 to about 15 seconds at a temperature of about 71° C. to about 90° C., or combinations thereof, which are known to those skilled in the art. Such UHT and HTST processing conditions are suitable for beverage compositions of the invention, whereby minimal opportunity for reactions between the components are provided. The composition is optionally cooled to about 2° C. to about 15° C. prior to filling into containers. Exemplary aseptic packages include a laminated container prepared from paperboard, polyethylene, e.g., low-density polyethylene (innermost layer), and aluminium; high density polyethylene (HDPE) plastic bottles; and the like.

The beverage compositions can be packaged, ready-to-drink, and can be shelf-stable. Any type of beverage packaging can be used to package the beverage composition including glass bottles, plastic bottles and containers (e.g., polyethylene terephthalate or foil lined ethylene vinyl alcohol), metal cans (e.g., coated aluminium or steel), lined cardboard containers, and the like. Other beverage packaging material known to one of ordinary skill in the art can be used.

This invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLES

### Example 1

The base formulation consisted of a 6% w/v trehalose solution in water, 10% w/v peptide source (PeptoPro, DSM), 30 mEq/L of sodium, 3 mEq/L potassium, about 10 mEq/L of chloride, 0.2% acidulant and 0.1% by weight of a flavoring agent. The mixture was prepared according to the following steps:

1. The trehalose and PeptoPro were dry blended together for 10 minutes. The total blend was then added slowly to water. Sufficient time was allowed for the blend to be completely dissolved.
2. Add sodium citrate and monopotassium phosphate with mild agitation.
3. Add 50% of the acidulent slowly and allow solution to mix for 15 minutes. Measure the pH. If pH is not less than 4.5 add 25% of the acidulent blend (half of that remaining), again allowing the solution to mix for 15 minutes taking pH measurements to ensure the pH does not drop below 3. Add remainder of the acidulent blend until pH reaches 4.3.
4. Add flavour.
5. Agitate for 15 minutes and measure the pH to ensure that it is 4.3.
7. Heat to 190° F. for 30 seconds and hot-fill into 250 ml pouches and cool immediately.

### Example 2

### Manufacture of Sport Drink—Liquid Format for Pouch Presentation (150 ml, 0% w/w caffeine)

### Formula Origin:

| Ingredient | Loading (% w/w) |
|---|---|
| Trehalose | 6 |
| PeptoPro | 2 |
| Citric acid | 0.5 |
| Sodium citrate | 0.153 |
| LoSalt | 0.049 |
| Natural grapefruit flavour | 1.76 |
| SyneROX 10 | 0.02 |
| Water | To volume |

Trehalose dihydrate (9 g) was added to 100 ml water and agitated until dissolution occurred. PeptoPro (3 g) was added to the resultant trehalose solution and agitation applied. Once dissolution was complete, citric acid (0.75 g), sodium citrate (0.23 g) and Losalt (66.6% potassium chloride: 33.3% sodium chloride, 0.73 g) were added to the solution. Once dissolution was complete, SyneROX10 (30 mg), and natural grapefruit liquid flavour (1.75 ml) were added to the resultant solution; the solution was then made to a 150 ml volume with water.

### Example 3

### Manufacture of Sport Drink—Liquid Format for Pouch Presentation (120 L, 0.035% w/w caffeine)

### Formula Origin:

| Ingredient | Loading (% w/w) |
|---|---|
| Trehalose | 6 |
| PeptoPro | 2 |
| Citric acid | 0.3 |
| Sodium citrate | 0.153 |
| LoSalt | 0.049 |
| Caffeine | 0.035 |
| SyneROX 10 | 0.02 |
| Natural grapefruit flavour | 1.17 |
| Water | To volume |

Trehalose dihydrate (7.2 kg) was added to 10 litres water and agitated until dissolution occurred. PeptoPro (2.4 kg) was added to the resultant trehalose solution and agitation applied; once dissolution was complete, citric acid (460 g), sodium citrate (184 g) and Losalt (66.6% potassium chloride: 33.3% sodium chloride 58.8 g) was added to the solution. Once dissolution was complete, SyneROX10 (24 g), caffeine (42.1 g) and natural grapefruit liquid flavour (1404 ml) were added to the resultant solution; the solution was then made to a 120 litre volume with water. The pH of the final formulation was 4.01

The formulation was pasteurised using a FT74X (Armfield Ltd) with a temperature—holding time profile of 79.5° C. and 6 seconds; the product was chilled on exit to 2-8° C. The pasteurised product was filled directly into 330 ml aluminium foil pouches with a sport cap in a Class II laminar cabinet.

The product was placed on stability for 6 months at room temperature and 40° C.; following 4 week, and 2 months storage, the product was evaluated using an assessment of formulation appearance, formulation aroma, formulation taste and the formulation microbiological loading (Total Aerobic Microbial Count and Total Yeast and Moulds Count). Data obtained over the 3 month period concluded the product was stable at both room and accelerated (40° C.) temperatures.

The inventive composition contained 19.8 g of trehalose, 6.6 g of PeptoPro and 115.5 mg of caffeine per pouch.

### Example 4

### Manufacture of Sport Drink—Liquid Format for Pouch Presentation (5.5 L, 0.05% w/w Caffeine)

### Formula Origin:

| Ingredient | Loading (% w/w) |
|---|---|
| Trehalose | 6 |
| PeptoPro | 2 |
| Citric acid | 0.3 |
| Sodium citrate | 0.153 |
| LoSalt | 0.049 |
| Caffeine | 0.05 |
| SyneROX 10 | 0.02 |
| Natural grapefruit flavour | 1.17 |
| Water | To volume |

Trehalose dihydrate (363 g) was added to 3000 ml water and agitated until dissolution occurred. PeptoPro (110 g) was added to the resultant trehalose solution and agitation applied; once dissolution was complete, citric acid (22.12 g), sodium citrate (8.41 g) and Losalt (66.6% potassium chloride: 33.3% sodium chloride 2.92 g) were added to the solution. Once dissolution was complete, SyneROX10 (1.097 g), caffeine (3.12 g) and natural grapefruit liquid flavour (64.3 ml) were added to the resultant solution; the solution was then made to a 5.5 litre volume with water. The pH of the final formulation was 3.95.

The formulation was pasteurised using a FT74X (Armfield Ltd) with a temperature—holding time profile of 76.2° C. and 12 seconds; the product was chilled on exit to 2-8° C.

The pasteurised product was filled directly into 100 ml aluminium foil pouches with a sport cap, using a Class II laminar cabinet.

The product was placed on stability for 6 months at room temperature and 40° C.; following 2 week, 3 week, 4 week, 2 months and 3 months storage, the product was evaluated using an assessment of formulation appearance, formulation aroma, formulation taste and the formulation microbiological loading (Total Aerobic Microbial Count and Total Yeast and Moulds Count). Data obtained over the 3 month period concluded the product was stable at both room and accelerated (40° C.) temperatures.

### Example 5

### Manufacture of Sport Drink with Thickener—Liquid Format for Pouch Presentation (100 ml, 0% w/w Caffeine)

### Formula Origin:

| Ingredient | Loading (% w/w) |
|---|---|
| Trehalose | 6 |
| PeptoPro | 2 |
| Citric acid | 0.3 |
| Sodium citrate | 0.153 |
| LoSalt | 0.049 |
| Natural grapefruit flavour | 1.17 |
| Clearcel CF 2000 | 0.05 |
| Water | To volume |

A Clearcel CF2000 solution was prepared by adding 0.15 g Clearcel CF2000 to 300 ml water; the resultant solution was homogenised using a Silverson mixer for 2 minutes. An aliquot (92 ml) was removed. To the Clearcel CF2000 solution aliquot, trehalose dihydrate (6 g) was added and the solution agitated until dissolution occurred. PeptoPro (2 g) was added to the resultant trehalose solution and agitation applied; once dissolution was complete, citric acid (0.3 g), sodium citrate (0.153 g) and Losalt (66.6% potassium chloride: 33.3% sodium chloride 0.049 g) were added to the solution. Once dissolution was complete, SyneROX10 (0.02 g), and natural grapefruit liquid flavour (1.17 ml) were added to the resultant solution.

### Example 6

### Manufacture of Sport Drink—Dry Powder Format for Sachet Presentation (Grapefruit, 0% w/w Caffeine)

### Formula Origin:

| Ingredient | Loading (% w/w) |
|---|---|
| Trehalose | 6 |
| PeptoPro | 2 |
| Citric acid | 0.5 |
| Sodium citrate | 0.153 |
| LoSalt | 0.049 |
| Spray-dried natural grapefruit flavour | 0.6 |
| Water | To volume |

Trehalose dihydrate (6 g), PeptoPro (3 g), citric acid (0.5 g), sodium citrate (0.153 g), Losalt (66.6% potassium chloride: 33.3% sodium chloride 0.73 g) and spray-dried natural grapefruit flavour (0.6 g) were all combined in a high shear mixer (coffee grinder).

The dry powder sample was placed on stability for 2 weeks at room temperature; no powder agglomeration was observed and on reconstitution, the formulation was found to exhibit the same appearance, aroma and taste observed for the initial samples.

### Example 7

### Manufacture of Sport Drink—Dry Powder Format for Sachet Presentation (Lemon, 0% w/w Caffeine)

### Formula Origin:

| Ingredient | Loading (% w/w) |
|---|---|
| Trehalose | 6 |
| PeptoPro | 2 |
| Citric acid | 0.4 |
| Sodium citrate | 0.153 |
| LoSalt | 0.049 |
| Spray-dried natural vanilla flavour | 0.25 |
| Spray-dried natural lemon flavour | 0.25 |
| Water | To volume |

Trehalose dihydrate (12 g), PeptoPro (4 g), citric acid (0.6 g), sodium citrate (0.306 g), Losalt (66.6% potassium chloride: 33.3% sodium chloride 0.98 g), spray-dried natural vanilla flavour (0.4 g) and spray-dried natural lemon flavour (0.4 g) were all combined in a high shear mixer (coffee grinder).

The dry powder sample was placed on stability for 2 weeks at room temperature; no powder agglomeration was observed and on reconstitution, the formulation was found to exhibit the same appearance, aroma and taste observed for the initial samples.

### Example 8

### Assessment in Amateur Soccer Players Using a Sprint Fatigue Test

The composition of Example 3 was administered to amateur soccer players in order to determine the effects of the composition on performance, endurance, fatigue and recovery. A sprint fatigue test was employed as part of a placebo-controlled, double-blind study.

A 20 metre running area was measured out. Subjects were administered either one 330 ml dose of the composition of Example 3 or a placebo, and a further 330 ml dose of the composition of Example 3, or a placebo, one hour later. Four subjects received the inventive composition; three subjects received the placebo.

The inventive composition contained 19.8 g of trehalose, 6.6 g of PeptoPro and 115.5 mg of caffeine per pouch; the total dose administered in two 330 ml pouches was 39.6 g of trehalose, 13.2 g of PeptoPro and 230 mg of caffeine. Assuming the average weight of the subjects is 75 kg, then the dose of caffeine administered was 3.06 mg/kg.

They were then requested to sprint from start A to finish B, a distance of 20 metres. They then had 30 seconds to return to the start, whereupon they repeated the sprint. They performed 3 sprints per test, followed by a 2 minute rest. This was repeated a further six times and the sprint times recorded. This was recorded as Session 1. Following a 1 hour rest, the 3 sprints were repeated a further six times and recorded as session 2. The total trial duration was approximately 3 hours. The subjects were also requested to complete a questionnaire designed to record ratings of focus, energy and fatigue throughout the trial, using a 10 cm visual analogue scale.

The median sprint time for placebo was 4.075 seconds; the median sprint time for active was 3.935 seconds. The improvement in median sprint time for the active versus placebo was 0.22 seconds, which translates to an improvement of a further 1 metre covered. Statistical analysis of the results (Mann Whitney) indicated that this difference was statistically significant (p<0.0004).

Fatigue between the two arms of the study and between each Session was calculated in two ways; the fatigue index was calculated by dividing the difference between the fastest and slowest sprints (drop-off) by the fastest time. The percentage decrement was calculated, as follows:

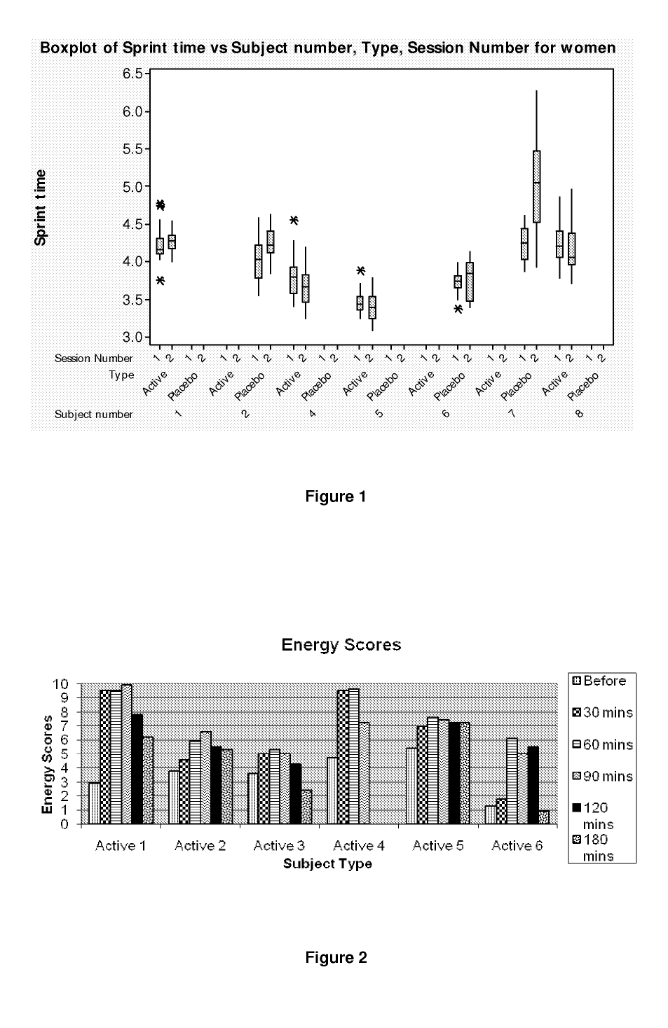

Fatigue−(100×(total sprint time/ideal print time))−100.

Where total sprint time=sum of the sprint times in the Session; ideal sprint time=number of sprints×fastest sprint time. The results are presented in Table 1 and FIG. 1.

TABLE 1

| | Mean Fatigue Index | Mean decrement percentage |
|---|---|---|
| Session 1 | | |
| Active | 0.27 | 10.95 |
| Placebo | 0.22 | 10.90 |
| Session 2 | | |
| Active | 0.25 | 10.23 |
| Placebo | 0.34 | 16.67 |

The mean fatigue index between Sessions for placebo has increased from 0.22 to 0.34 (+54%), whereas the mean fatigue index for active has actually reduced from 0.27 to 0.25 (−8%). Similar trends were found using the percentage decrement value (+65% for placebo, −7% for active).

### Example 9

### Assessment in Amateur Soccer Players During a Match

The composition of Example 4 was provided to a women's amateur soccer team, prior to a local Cup match. This test was designed to assess the effects of the inventive composition in a real sports situation. Six players consumed one 330 ml pouch an hour before kick-off followed by a further 330 ml pouch just before kick-off. The subjects were also requested to complete a questionnaire designed to record ratings of focus, energy and fatigue throughout the match, using a 10 cm visual analogue scale. The results are presented in FIG. 2, which reveals all six subjects recorded energy levels at 90 minutes after consumption of the first pouch which were greater than before consumption. Furthermore, five of the six subjects reported energy levels at 120 minutes after consumption of the first pouch which were greater than before consumption. Indeed, three of the six subjects reported energy levels at 180 minutes after consumption of the first pouch which were greater than before consumption.

### Example 9

Example 7 was repeated with a group of eight professional cricket players, except the subjects were not permitted to consume any carbohydrates or caffeine e.g. tea, coffee, caffeine-containing beverages or supplements, on the morning of the test. They were also administered a controlled breakfast (2 eggs) and permitted to drink a maximum of 500 ml water only, from waking until taking part in the test. They were then requested to sprint from start A to finish B, a distance of 20 metres. They then had 30 seconds to return to the start, whereupon they repeated the sprint. They performed six sprints per test, followed by a 2 minute rest. This was repeated a further five times and the sprint times recorded. This was recorded as Session 1. Following a 1 hour rest, the six sprints were repeated a further five times and recorded as session 2. The total trial duration was approximately 3 hours. Fatigue index was calculated as described in Example 7. The results are presented in Table 2.

TABLE 2

| | Mean Fatigue Index |
|---|---|
| Session 1 | |
| Active | 0.024 |
| Placebo | 0.047 |
| Session 2 | |
| Active | 0.038 |
| Placebo | 0.048 |

These data indicate that there was a surprising 48.9% reduction in fatigue for the active compared to placebo in Session 1, and a 20.8% reduction in fatigue for the active compared to placebo in Session 2.

1. A nutritional composition, comprising trehalose and a peptide source or a stimulant selected from caffeine or taurine, wherein the average length of the peptide(s) is from about 3 to 9 amino acids.

2. A nutritional composition according to claim 1, comprising the peptide source and the stimulant selected from caffeine or taurine.

3. A nutritional composition according to claim 1 or claim 2, wherein said peptide source is a protein hydrolysate selected from a whey hydrolysate which comprises peptides wherein the molar fraction of peptides carrying a carboxy terminal proline is at least 8%, a casein hydrolysate which comprises peptides wherein the molar fraction of peptide carrying a carboxy terminal proline is at least 25%, or a soy hydrolysate which comprises peptides wherein the molar fraction of peptides carrying a carboxy terminal proline is at least 20%.

4. A nutritional composition according to claim 1, wherein the weight ratio of trehalose to said peptide source is from about 95:5 to about 5:95.

5. A nutritional composition according to claim 1, further comprising at least one electrolyte selected from salts of sodium, calcium, potassium, magnesium, chloride, or a combination thereof.

6. A nutritional composition according to claim 1, wherein the dose of caffeine is at least from about 3 mg/kg or more, or from about 5 mg/kg or more, or from about 6 mg/kg or more.

7. A solid or semi-solid edible nutritional composition comprising at least 5% of a composition according to claim 1.

8. A nutritional composition according to claim 7, wherein the solid or semi-solid edible composition is selected from the group consisting of tablets, bars, confectionery, gels, drink powders, diabetic food, baby food, infant food, dietetic food, slimming food, food for special dietary needs, and medical food.

9. A nutritional composition according to claim 1, in beverage form, wherein the composition further comprises a liquid selected from carbonated water, flavoured water, carbonated flavoured water, spring water, fruit juice, vegetable juice or nectar, coffee, decaffeinated coffee, tea, tea derived from fruit products, tea derived from herb products, decaffeinated tea, wine, champagne, malt liquor, rum, gin, vodka, other hard liquors, milk obtained from animals, milk product derived from soy, rice, coconut or other plant material.

10. A nutritional composition according to claim 9, characterized in that said beverage is selected from the group consisting of ready-to-drink beverages, beverage concentrates, hypotonic beverages, soft drinks, shots, sports drinks, hypertonic beverages, energy drinks, and isotonic beverages.

11. A nutritional composition according to claim 10, characterized in that said beverage optionally further comprises one or more amino acids, antioxidants, fats, vitamins, trace elements, electrolytes, intense sweeteners, flavours and/or mixtures thereof, caffeine, colouring agents, emulsifiers, flavour potentiators, food-grade acids, minerals, micronutrients, plant extracts, phytochemicals preservatives, salts including buffering salts, stabilizers, thickening agents, medicaments, vitamins, fibres, prebiotics, probiotics, and/or a combination thereof.

12. A composition according to claim 9, wherein the composition is a ready-to-drink beverage, optionally in a pouch.

13. (canceled)

14. A method for improving muscle performance and/or to extend endurance during exercise and/or to promote recovery after exercise, and/or reduce physical and/or mental impairment of the subject following said exercise comprising administering a composition according to claim 1 to a subject during and/or shortly before prolonged physical exercise.

15. The method according to claim 14, wherein said source of peptides is a protein hydrolysate selected from a whey hydrolysate which comprises peptides wherein the molar fraction of peptides carrying a carboxy terminal proline is at least 8%, a casein hydrolysate which comprises peptides wherein the molar fraction of peptide carrying a carboxy terminal proline is at least 25%, or a soy hydrolysate which comprises peptides wherein the molar fraction of peptides carrying a carboxy terminal proline is at least 20%.

16. The method according to claim 14, wherein the nutritional composition is selected from the group consisting of tablets, bars, confectionery, beverages, beverage concentrates, gels, drink powders, diabetic food, baby food, infant food, dietetic food, slimming food, food for special dietary needs, and medical food and combinations thereof.

17. The method according to claim 16, wherein said beverage is selected from the group consisting of hypotonic beverages, soft drinks, shots, sports drinks, hypertonic beverages, energy drinks, and isotonic beverages.

18. The method according to claim 16, wherein said beverage also comprises at least one electrolyte selected from salts of sodium, calcium, potassium, magnesium, chloride, or a combination thereof.

19. The method according to claim 14, wherein the step of oral administration comprises administration of at least 0.1 g of trehalose per kg body weight of the person, preferably at least 0.3 g/kg and more preferably at least 0.5 g/kg, and wherein the dose of caffeine, if present, is at least from about 3 mg/kg or more, or from about 5 mg/kg or more, or from about 6 mg/kg or more.

20. (canceled)

21. The method according to claim 14, wherein the composition comprises a peptide source and the stimulant is caffeine or taurine.
